(19) United States
(12) Patent Application Publication
(10) Pub. No.: US 2024/0242109 A1
(43) Pub. Date: Jul. 18, 2024

(54) MULTILEVEL OVERSAMPLER

(71) Applicant: Accenture Global Solutions Limited, Dublin (IE)

(72) Inventors: Harshaprabha N. Shetty, Bangalore (IN); Sony Asampalli, Hyderabad (IN); Prabhu Vara Prasad Bonam, Kukatpally (IN); Tanusree De, Bangalore (IN)

(21) Appl. No.: 18/098,532

(22) Filed: Jan. 18, 2023

(51) Int. Cl. G06N 20/00; G06F 18/213; G06F 18/22

(52) U.S. Cl. CPC G06N 20/00; G06F 18/213; G06F 18/22

(57) ABSTRACT

Methods, systems, and apparatus, including computer programs encoded on computer-storage media, for oversampling training data for training a machine learning model. In some implementations, techniques described enable debiasing of trained models through oversampling of training data. In general, training data can be partitioned into multiple levels corresponding to specific elements of data, e.g., type of tumor, type of individual, time of day, among others. A given level can be associated with higher bias than other levels. For example, input data of a particular type of individual, such as an individual of a certain age range or with certain genetic traits, can cause corresponding machine learning model predictions or results that are more biased compared to other data. Higher bias can include an increased number of false positives or false negatives for Boolean model predictions or predictions.

### FIELD

This specification generally relates to training a machine learning model using a type of oversampled training data.

### BACKGROUND

Accuracy of machine learning models can depend heavily on the data used to train the models. As an example, a machine learning model trained to detect objects in images using training images that include only a single specific object may become biased to detect that specific object, and potentially miss other objects in the images.

For prediction on decision making, similar issues may arise. For instance, machine learning models trained to detect tumors in patients based on internal imaging can be biased towards false negatives if the training data is predominately false negative examples. This can have life or death consequences. In other areas, the effects of model bias can be less severe but strong enough to degrade efficacy of machine learning models.

### SUMMARY

One innovative aspect of the subject matter described in this specification is embodied in a method that includes obtaining a first data set that includes data of multiple attribute levels including a minority level and a majority level; extracting one or more samples from the first data set representing the minority level; generating one or more values representing a distance between a sample of the minority level and the one or more samples of the minority level; generating a sample rate for the minority level using the one or more values representing the distance; generating a second data set by (i) sampling a second set of samples from a distribution using the sample rate and (ii) combining the second set of samples with the first data set; providing a portion of the second data set to a machine learning model; obtaining output of the machine learning model representing a prediction using the portion of the second data set; comparing the output with a ground truth value included in a portion of the second data set not provided to the machine learning model; and adjusting the machine learning model using one or more values indicating the comparison between the output and the ground truth value.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the second data set includes more samples representing the minority level than the first data set.

In some implementations, generating the one or more values representing the distance between the sample of the minority level and the one or more samples of the minority level includes: generating one or more values representing an average of each feature describing each sample of the first data set; and generate one or more values representing a correlation of each feature describing each sample of the first data set. In some implementations, the one or more values representing the correlation include a covariance matrix. In some implementations, actions include generating a transposition of the one or more values indicating the distance.

In some implementations, generating the sample rate for the minority level using the one or more values representing the distance includes: combining a portion of the one or more values representing the distance; modifying the combination of the portion of the one or more values using a reciprocal of a combination of the one or more values representing the distance; and generating a matrix of values including the sample rate for the minority level using the modified combination of the portion of the one or more values.

In some implementations, actions include generating a second sample rate for a second minority level of the first data set or the majority level using the one or more values representing the distance, where the second sample rate is less than the sample rate for the minority level.

In some implementations, the minority level represents one or more attributes with a likelihood of bias higher than one or more attributes represented by the majority level in the first data set, and a bias of the one or more attributes of the minority level in the second data set is less than the one or more attributes of the minority level in the first data set. In some implementations, a higher bias indicates a greater likelihood of inaccurate results from the machine learning model.

Advantageous implementations can include one or more of the following features. For example, by focusing the oversampling process on data points that truly need to be oversampled—and in turn reducing redundant oversampling—the proposed techniques can result in models that are more accurate or that can be trained more efficiently as compared to, for example, models that use brute force or uniform oversampling. In one example test run, computation time for the techniques described took 0.046% of the time required for oversampling on the same training data to be performed by a traditional multiclass oversampler Synthetic Minority Over-sampling Technique (SMOTE). Resulting accuracy of a model trained with the training data oversampled with the techniques described increased by 4% compared to a model trained with the training data oversampled with SMOTE. In some cases, systems employing the techniques described herein can consume less energy or use less processing resources as compared to traditional oversampling techniques such as SMOTE, thereby aiding in achieving lower carbon emissions. Efficiency and accuracy improvements can enable machine learning model usage in areas where time for training data generation or processing requirements have been obstacles to usage.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for oversampling training data for training a machine learning model.

FIG. 2 is a flow diagram illustrating an example of a process for oversampling training data.

FIG. 3 is a diagram illustrating an example of a computing system used for oversampling training data.

Like reference numbers and designations in the various drawings indicate like elements.

### DETAILED DESCRIPTION

In some implementations, techniques described in this document enable debiasing of trained models through oversampling of training data. In general, training data can be partitioned into multiple levels corresponding to specific elements of data, e.g., type of tumor, type of individual, time of day, among others. A given level can be associated with higher bias than other levels. For example, input data of a particular type of individual, such as an individual of a certain age range or with certain genetic traits, can cause corresponding machine learning model predictions or results that are more biased compared to other data. Higher bias can include an increased number of false positives or false negatives for Boolean model predictions or predictions.

The techniques described herein provides solutions to adjust the training data such that bias within a trained model is potentially mitigated. For example, the techniques can include generating one or more distance values based on a given level of data that causes biased results for a machine learning model. The distance values can then be used to generate a sample rate for the given level of data. The sample rate can determine how many additional samples to generate for the corresponding level of data. The sample rate can be proportional to a distance between a data point of an attribute level and other data points of the same attribute level. Each individual data point within a data set can be oversampled according to a sampling rate proportional to its distance to one or more other data points.

For example, the techniques described herein identifies outliers that may be underrepresented in the training data, and oversamples such outliers appropriately. The oversampling rate in turn can depend on a metric that represents how much of an outlier a data point is. For example, the training data can be mapped on an n-dimensional space and a distance of an outlier data point can be calculated from a reference point. The distance can represent an extent of oversampling. For example, in some cases, the oversampling rate can be directly proportional to the distance. The sampling rate can depend on the distance, or another similar metric, in various other ways. For example, the sampling rate can vary inversely with the distance, as a square of the distance, or as another function of the distance depending, for example, on the specific type or content of training data.

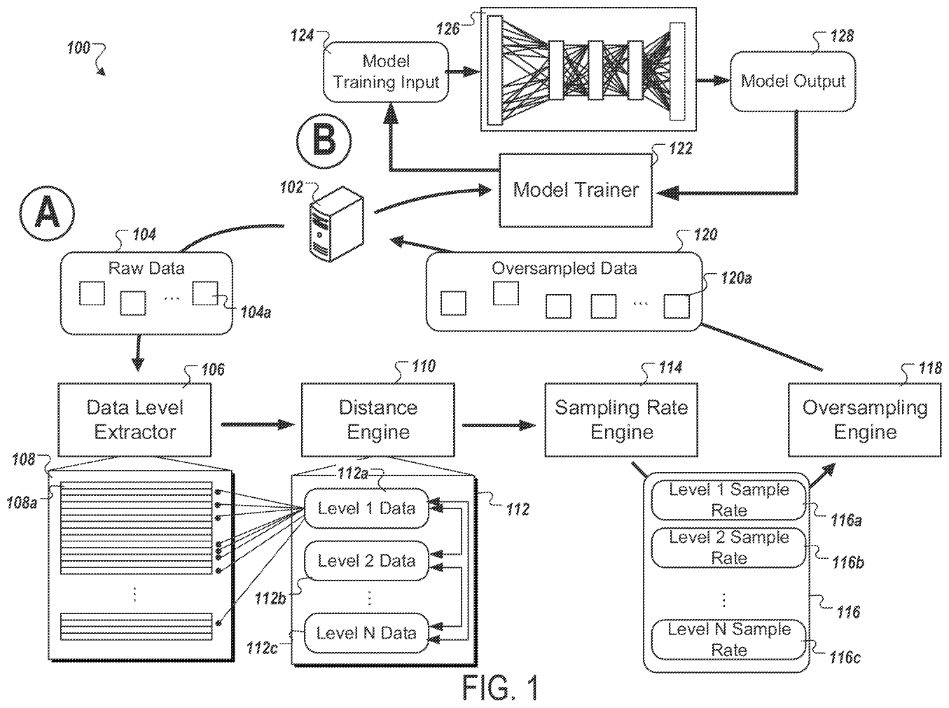

FIG. 1 is a diagram showing an example of a system 100 for oversampling training data for training a machine learning model 126. One or more computer processors, represented by computer 102, provides raw data 104 to a data level extractor 106. Based on the data levels, a distance engine 110 generates one or more values indicating distances between the levels of data shown graphically in 112. A sampling rate engine 114 generates sample rates for one or more levels of the data 104 shown in 116. An oversampling engine 118 then samples from a distribution of values to generate new data items. The new data items can be combined with the raw data 104 to generate oversampled data 120. The computer 102 can provide the oversampled data 120 to a model trainer 122 for training the machine learning model 126 using the oversampled data 120.

FIG. 1 is described using stages A and B for ease of reference. In stage A, the computer 102 generates the oversampled data 120 from the raw data 104. In stage B, the computer 102 trains the model 126 using the oversampled data 120 generated in stage A of FIG. 1.

In some implementations, the raw data 104 includes multiple levels. For example, data item 104a included in the raw data 104 can represent data corresponding to an individual. The data item 104a can include information that describes the individual, such as income, home address, name, ethnicity, among others. The raw data 104 can include other data items of different levels, e.g., data where one or more attributes are different from the data item 104a.

The computer 102 provides the raw data 104 to the data level extractor 106. In some implementations, the computer 102 includes one or more processors that operate the data level extractor 106. For example, the computer 102 can include one or more processors that perform one or more operations described as being performed by the data level extractor 106.

In some implementations, the data level extractor 106 parses the raw data 104 to determine one or more values corresponding to a given data item, such as the data item 104a. For example, the data level extractor 106 can parse the data item 104a and determine that the data item 104a includes data for an individual indicating the individual's name, address, ethnicity, and income. In some implementations, the computer 102 provides an instruction to the data level extractor 106 to use specific data as criteria for data levels. For example, the computer 102 can provide an instruction to the data level extractor 106 to use one or more income ranges as criteria for data levels or one or more ethnicities, among others. The data level extractor 106 can select one or more data items as corresponding to a given data level based on the provided instructions.

In some implementations, the data level extractor 106 determines one or more data levels. For example, the data level extractor 106 can obtain instructions, e.g., from the computer 102, to use specific criteria for specific types of data. The data level extractor 106 can determine a type of data and determine a corresponding criteria for that particular type of data. For example, a first type of data can include data items that include one or more predetermined types of data, e.g., income, ethnicity, among others.

The data level extractor 106 provides data items corresponding to particular data levels to the distance engine 110. In some implementations, the computer 102 includes one or more processors that operate the distance engine 110. For example, the computer 102 can include one or more processors that perform one or more operations described as being performed by the distance engine 110.

The distance engine 110 generates one or more values representing distances between one or more data points of the raw data 104. In some implementations, the distance engine 110 compares data items determined to correspond to a first level 112a. In some implementations, the distance engine 110 compares data items of the first level 112a with one or more other data items, e.g., data items of a second level 112b or Nth level 112c. In general, the data level extractor 106 can extract data items of the raw data 104 into any number of data levels. Data levels determined by the data level extractor 106 in the example of FIG. 1 are shown in 112, e.g., data of a first level 112a, second level 112b, an Nth level 112c.

In some implementations, the distance engine 110 generates distance values only for levels determined to be minority levels. For example, the distance engine 110 can determine which of the data levels determined by the data level extractor 106 are minority levels. In some implementations, a data level is determined by the distance engine 110 to be a minority level when a training data threshold is satisfied. For example, the distance engine 110 can determine a ratio for each of the data levels determined by the data level extractor 106. The ratio can include a ratio of one or more types of training data (e.g., data items with a particular value or type of value) compared to one or more other types of training data (e.g., data items with another particular value or type of value). In an example where the raw data 104 includes a Boolean value, a ratio for a given data value can include a number of data items with a data element of “True,” or other similar value, compared to a number of data items with a data element of “False,” or similar.

In some implementations, the distance engine 110 compares one or more values generated for one or more levels to a threshold to determine which levels satisfy a threshold for being a minority level. For example, the distance engine 110 can compare a ratio of the first level data 112, e.g., a ratio of Boolean “True” values compared to Boolean “False” values within data included in the first level data 112, to a threshold ratio. In some implementations, the distance engine 110 ranks one or more values for one or more levels. For example, the distance engine 110 can rank values generated for each of the levels determined by the data level extractor 106. A threshold number of levels within the ranking can be determined by the distance engine 110 to be a minority level, e.g., highest ratio, lowest ratio, highest N ratios, lowest N ratios, middle ratio, middle N ratios, among others.

In some implementations, the distance engine 110 generates distance values for a given data item. For example, the distance engine 110 can generate one or more distance values for the data item 104a. The distance engine 110 can generate the one or more distance values by determining a vector corresponding to the data item 104a and comparing the vector corresponding to the data item 104a with one or more data items of the first level data 112a or the raw data 104.

In some implementations, the distance engine 110 determines a vector corresponding to the data item 104a using data elements of the data item 104a. For example, the data item 104a can include one or more data elements representing information, such as name of an individual, income, medical history, family history, ethnicity, previous visits, loan information, among others. The distance engine 110 can generate a vector for the data item 104a that represents one or more values for the one or more data elements, e.g., a data item that includes information such as income=$40,000 and ethnicity=Asian can be represented in a vector as [40000,3] where “3” represents the Asian ethnicity. In general, the distance engine 110 can use numeric or non-numeric values in vectors to represent data stored in a data item, such as the data item 104a.

In some implementations, the distance engine 110 generates distance values for a given data item using a vector representing the data item. For example, as discussed, the distance engine 110 can generate a vector representing the data item 104a. The distance engine 110 can generate one or more distance values for the data item 104a by comparing the determined vector to other determined vectors of other points in a same data level as the data item 104a or other data levels of the raw data 104. The oversampling engine 118 can determine a sampling rate that is generally proportional to a distance for a given data item.

In some implementations, the distance engine 110 generates distance values for a given data item using a vector representing the data item and a vector representing one or more other data items. For example, the distance engine 110 can generate a mean vector using one or more other data items, e.g., from a same data level as a data item being compared to or from other data levels, and compare the mean vector to a vector representing a given data item. The mean vector can include one or more values of the same type as a data item being compared to, e.g., the data item 104a. For example, the mean vector can include a mean income value representing a mean value of all data items in the data level of the data item 104a, all data items except the data item 104a, all data items in the raw data 104, or all data items in the raw data 104 except the data item 104a, among others. The distance engine 110 can compare the mean vector to a vector of the data item 104a, including, in some implementations, comparing an income data variable of the vectors.

In some implementations, the distance engine 110 generates one or more distance values by transposing one or more values. For example, the distance engine 110 can transpose a difference between a vector of a given data item and one or more vectors of one or more other data items. In some implementations, the distance engine 110 performs operations corresponding to the following equation:

$${[ {( {X}_{B} - {X}_{A} )}^{T} * {C}^{- 1} * ( {X}_{B} - {X}_{A} ) ]}^{0.5}$$

where X_{B} represents a vector of a given data item, e.g., data item 104a, X_{A} represents a vector for one or more data items, e.g., a mean vector averaging one or more values of one or more data items or one or more vectors representing one or more data items, C⁻¹ represents an inverse covariance matrix of independent variables, e.g., variables represented as information in one or more data items of the raw data 104, and a dimension of the corresponding matrix representing one or more distance values can be N by N where N represents the number of data items in the raw data 104.

A result of distance value generation for one or more data items by the distance engine 110 can be represented as shown in the following Table 1:

| | First Data | Second | Fourth | | |
|---|---|---|---|---|---|
| | Level | Data Level | Data Level | Fifth Data Level | Nth Data Level |
| First Data Level | [[0 | 2.60175339 | 2.53893373 | 2.66824052 | 2.56099461] |
| Second Data | [2.60175339 | 0 | 1.92107412 | 2.62868794 | 0.50381315] |
| Level | | | | | |
| Fourth Data | [2.53893373 | 1.92107412 | 0 | 0.73411255 | 1.43592733] |
| Level | | | | | |
| Fifth Data | [2.66824052 | 2.62868794 | 0.73411255 | 0 | 2.15669461] |
| Level | | | | | |
| Nth Data Level | [2.56099461 | 0.50381315 | 1.43592733 | 2.15669461 | 0]] |

Table 1 above shows distance values between the first level data 112a, the second level data 112b, and the Nth level data 112c, as well as fourth and fifth level data not shown in FIG. 1. Table 1 does not include third level data. In some implementations, the distance engine 110 only determines distance values between minority data levels. For example, the third data level can represent a non-minority data level, or majority data level. Because it is not a minority level, it can be not oversampled and therefore no distance values are needed to be generated.

The distance engine 110 provides one or more distance values to the sampling rate engine 114. In some implementations, the distance engine 110 provides data similar to the data shown in Table 1. The sampling rate engine 114 generates sampling rates for one or more data items based on the corresponding distance values generated by the distance engine 110. In some implementations, the computer 102 includes one or more processors that operate the sampling rate engine 114. For example, the computer 102 can include one or more processors that perform one or more operations described as being performed by the sampling rate engine 114.

In some implementations, the sampling rate engine 114 determines sampling rates using a probability matrix. For example, in the example above where the distance engine 110 provides a matrix of distance values to the sampling rate engine 114, the sampling rate engine 114 can determine a probability weight and generate a new matrix that is scaled by the probability weight. For example, the sampling rate engine 114 can determine one or more probability weights using the values provided by the distance engine 110 shown in Table 1. The corresponding probability weights can be generated as a column's sum divided by the total sum of the distance matrix. Probability weights corresponding to the values of Table 1 can be represented by the matrix: [2.72238037, 1.48362956, 1.11283586, 1.69717031, 1.12204683].

In some implementations, the sampling rate engine 114 determines sampling rates using a normalized version of one or more distance values provided by the distance engine 110. For example, the sampling rate engine 114 can determine a sum of the distances provided by the distance engine 110 and divide one or more distances provided by the distance engine 110 by the sum. For example, if the sum of the distances provided by the distance engine 110 is 8.138 and probability values determined by the sampling rate engine 114 include [2.72238037, 1.48362956, 1.11283586, 1.69717031, 1.12204683], the normalized one or more distance values can be represented as [0.33452437, 0.18230746, 0.13674456, 0.20854721, 0.1378764].

In some implementations, the sampling rate engine 114 uses a normalized version of one or more distance values and an oversampling percentage to determine one or more oversampling rates. For example, the sampling rate engine 114 can determine a sampling rate for one or more data levels determined by the data level extractor 106. The sampling rate engine 114 can obtain an oversampling percentage that is scaled by a set of values determined by the sampling rate engine 114, e.g., a normalized version of one or more distance values. In some implementations, the sampling rate engine 114 obtains the oversampling percentage from the computer 102. A user of the system 100 can provide an oversampling percentage using a user interface. The provided oversampling percentage can be provided by the computer 102 to the sampling rate engine 114.

In some implementations, the sampling rate engine 114 determines an oversampling percentage based on the raw data 104, e.g., a type or one or more values representing the raw data 104. For example, for a first type of one or more values, the sampling rate engine 114 can determine a first percentage. For a second type of one or more values, the sampling rate engine 114 can determine a second percentage. The percentage can control a number of oversampled data items added to an oversampled data set, e.g., oversampled data 120.

In some implementations, the sampling rate engine 114 determines one or more sampling rates for one or more data items of the data levels determined by the data level extractor 106. For example, the sampling rate engine 114 can scale a normalized version of one or more distance values by an oversampling percentage to determine sampling rates for one or more data levels determined by the data level extractor 106. In an example, the oversampling percentage can be 203%. A normalized version of one or more distance values can be represented as [0.33452437, 0.18230746, 0.13674456, 0.20854721, 0.1378764] where each value of the vector corresponds to a data level determined by the data level extractor 106, e.g., first data level 112a, second data level 112b, fourth data level, fifth data level, and Nth data level 112c. Scaling the normalized version of one or more distance values by the oversampling percentage, the data level extractor 106 can generate a set of oversampling rates which can be represented as [0.6806, 0.3709, 0.2782, 0.4243, 0.2805] where each oversampling rate corresponds to a data level determined by the data level extractor 106, e.g., first data level 112a, second data level 112b, fourth data level, fifth data level, and Nth data level 112c. Of course, the data levels and values used here are for ease of understanding the techniques and should not be read to limit the techniques described.

The sampling rate engine 114 provides one or more sampling rates 116 to the oversampling engine 118. In some implementations, the computer 102 includes one or more processors that operate the oversampling engine 118. For example, the computer 102 can include one or more processors that perform one or more operations described as being performed by the oversampling engine 118. The oversampling engine 118 samples from a distribution according to the rates 116 provided by the sampling rate engine 114. In some implementations, the oversampling engine 118 generates additional data items. For example, the oversampling engine 118 can determine a number of samples for a given data level, e.g., the first data level 112a, within the raw data 104. The oversampling engine 118 can use a first level sample rate 116a provided by the sampling rate engine 114 and a determined number of samples for the first level, e.g., first level data 112a, to determine a number of data items to be generated. The oversampling engine 118 can generate a number of new data items to be added to the raw data 104, where the number represents a result of multiplying the first level sample rate 116a by the determined number of samples for the first level. Similar calculations can determine how many data items to generate for other data levels. In some implementations, sampling rate varies from level to level and calculation is done for all the levels simultaneously, e.g., by one or more threaded or multiple processors.

In some implementations, each data item generated by the oversampling engine 118 includes values that differ from one or more data items already in the raw data 104. For example, the oversampling engine 118 can sample from a distribution of values for a given parameter of each data item in the raw data 104 for a given data level. The distribution can be normalized with areas of more common values given a higher likelihood of being sampled compared to less common values. The oversampling engine 118 can choose any real number values between or on previous values included in the raw data 104. The oversampling engine 118 can generate a data item by sampling one or more distributions where each distribution corresponding to a given data element within data items of the raw data 104 or data items of a given data level. In some implementations, the oversampling engine 118 randomly selects values within a given distribution corresponding to a data element value.

In some implementations, the oversampling engine 118 samples additional data items within an area around a given data item. For example, for a sampling rate of a given data item, the oversampling engine 118 can determine a distance within data element value space within which to randomly select a value for a data element of a newly generated oversampled data item. The distance can be preset or dynamic based on a value of the data item. For example, if the data item includes an income value of $40,000, the oversampling engine 118 can generate an oversampled data item for the data item within a predetermined region around the value $40,000, e.g., plus or minus $1,000, or a dynamic region around the value $40,000, e.g., plus or minus 2% of the value.

The oversampling engine 118 generates the oversampled data 120 including a new oversampled data item generated by the oversampling engine 118. The oversampling engine 118 provides the oversampled data 120 to the computer 102. In stage B, the computer 102 provides the oversampled data 120 to the model trainer 122. The model trainer 122 trains the machine learning model 126. The machine learning model 126 can include one or more layers, weights, or parameters to iteratively process input data to generate a result or prediction based on the input data. In some implementations, the computer 102 includes one or more processors that operate the model trainer 122. For example, the computer 102 can include one or more processors that perform one or more operations described as being performed by the model trainer 122.

The model trainer 122 provides model training input 124 to the machine learning model 126. The model training input 124 can include one or more portions of the oversampled data 120. In some implementations, the model training input 124 includes only a non-ground truth portion of the oversampled data 120. For example, the model trainer 122 can obtain the oversampled data 120 that includes both ground truth data and input data. The model trainer 122 can separate the ground truth data from the input data and provide just the input data to the machine learning model 126. The model trainer 122 can obtain model output 128 representing a prediction or other result generated by the machine learning model 126 processing the model training input 124. The model trainer 122 can compare the model output 128 to ground truth data included in the oversampled data 120 or obtained from another device or storage database.

In some implementations, ground truth data can include a Boolean value, e.g., a tumor exists, a tumor doesn't exist, approved for loan, not approved for loan, likelihood of reoffense, among others, or other value, e.g., a predicted malignancy value of a tumor, a predicted loan amount, among others. The model trainer 122 can compare the ground truth data corresponding to the oversampled data 120 with the model output 128 to generate an error term. The model trainer 122 can use the error term to adjust one or more weights or parameters of the machine learning model 126. In some implementations, the model trainer 122 uses one or more training algorithms, such as gradient descent, to adjust one or more parameters of the model 126. In some implementations, one or more iterations of training occur before oversampling. In some implementations, training of the machine learning model 126 occurs over one or more iterations of training. For example, a training iteration can include providing the model training input 124 and using corresponding output 128 to adjust, or not adjust, the machine learning model 126.

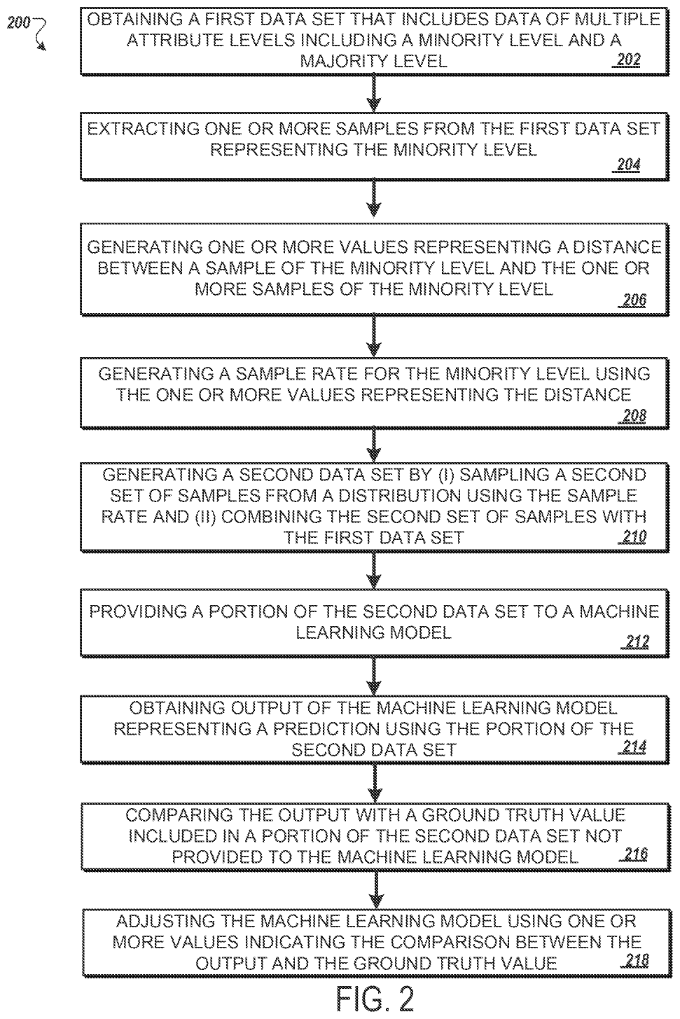

FIG. 2 is a flow diagram illustrating an example of a process 200 for oversampling training data. The process 200 may be performed by one or more electronic systems, for example, the system 100 of FIG. 1.

The process 200 includes obtaining a first data set that includes data of multiple attribute levels including a minority level and a majority level (202). For example, the data level extractor 106 can obtain the raw data 104 from the computer 102. The raw data 104 can include data of multiple attribute levels including a minority level and a majority level, e.g., first level data 112a and third level data not shown. The data can include a particular variable, e.g., sensitive variable, that is included in multiple data levels. A given sensitive variable can depend on a particular service scenario and can include variables relating to name of an individual, income, medical history, family history, ethnicity, previous visits, loan information, among others.

The process 200 includes extracting one or more samples from the first data set representing the minority level (204). For example, the data level extractor 106 can extract data items from the raw data 104 corresponding to a minority level, such as the first level data 112a. In some implementations, a minority level include all data with a particular type of data element or data element value. For example, a minority level can include all data items of the raw data 104 with a data element corresponding to income level within a determined range.

The process 200 includes generating one or more values representing a distance between a sample of the minority level and the one or more samples of the minority level (206). For example, the distance engine 110 can generate one or more distance values. The one or more distance values can represent distances between a given point within a data level and a point within the same data level or different data level. In some implementations, the one or more distance values are generated by the distance engine 110 in a matrix of elements. In some implementations, a distance between a sample of the minority level and the one or more samples of the minority level represents a cumulative distance between a given sample of a minority level and the one or more other samples of the minority level, such as one or more samples not including the given sample of the minority level. For example, the one or more values can indicate an average or one or more values that represent multiple distances between a point representing the given sample of a minority level and the one or more samples of the minority level, such one or more samples different than the given sample of a minority level.

The process 200 includes generating a sample rate for the minority level using the one or more values representing the distance (208). For example, the sampling rate engine 114 can generate a sampling rate for one or more data levels or one or more data items within the raw data 104. In the example of FIG. 1, the rates 116 generated by the sampling rate engine 114 include sampling rates for each data level determined by the data level extractor 106. In some implementations, the sampling rate engine 114 only generates sampling rates for minority data levels or data items within minority data levels.

The process 200 includes generating a second data set by (i) sampling a second set of samples from a distribution using the sample rate and (ii) combining the second set of samples with the first data set (210). For example, the oversampling engine 118 can obtain the rates 116 generated by the sampling rate engine 114. The oversampling engine 118 can generate one or more new data items to be added to the raw data 104 to generate the oversampled data 120. For example, the oversampling engine 118 can generate the new data item 120a which can be combined with preexisting data item 104a within the newly generated oversampled data 120.

The process 200 includes providing a portion of the second data set to a machine learning model (212). For example, the computer 102 can provide the oversampled data 120 to the model trainer 122. The model trainer 122 can provide the model training input 124 to the machine learning model 126. The model training input 124 can include one or more portions of the oversampled data 120, such as input data of the oversampled data 120 without corresponding ground truth data.

The process 200 includes obtaining output of the machine learning model representing a prediction using the portion of the second data set (214). For example, the model trainer 122 can obtain the model output 128. The model output 128 can represent a result or prediction of the machine learning model 126 operating on the model training input 124.

The process 200 includes comparing the output with a ground truth value included in a portion of the second data set not provided to the machine learning model (216). For example, the model trainer 122 can compare the model output 128 to one or more ground truth values. The ground truth values can indicate what an accurate or real life prediction or result is. The model trainer 122 can use the ground truth values to determine whether or not the model output 128 generates predictions or results that are accurate or are within one or more thresholds of an accurate or real life value.

The process 200 includes adjusting the machine learning model using one or more values indicating the comparison between the output and the ground truth value (218). For example, the model trainer 122 can adjust one or more weights or parameters of the machine learning model 126. In some implementations, the model trainer 122 implements one or more model training algorithms to train the machine learning model 126. For example, the model trainer 122 can implement a gradient descent algorithm to determine one or more gradients based on the model output 128 and ground truth values and adjust one or more weights or parameters of the machine learning model 126 based on the gradients. The model trainer 122 can continue training iterations until a threshold accuracy is reached by output of the model 126 as determined by a degree of similarity determined between output of the model 126 and ground truth data.

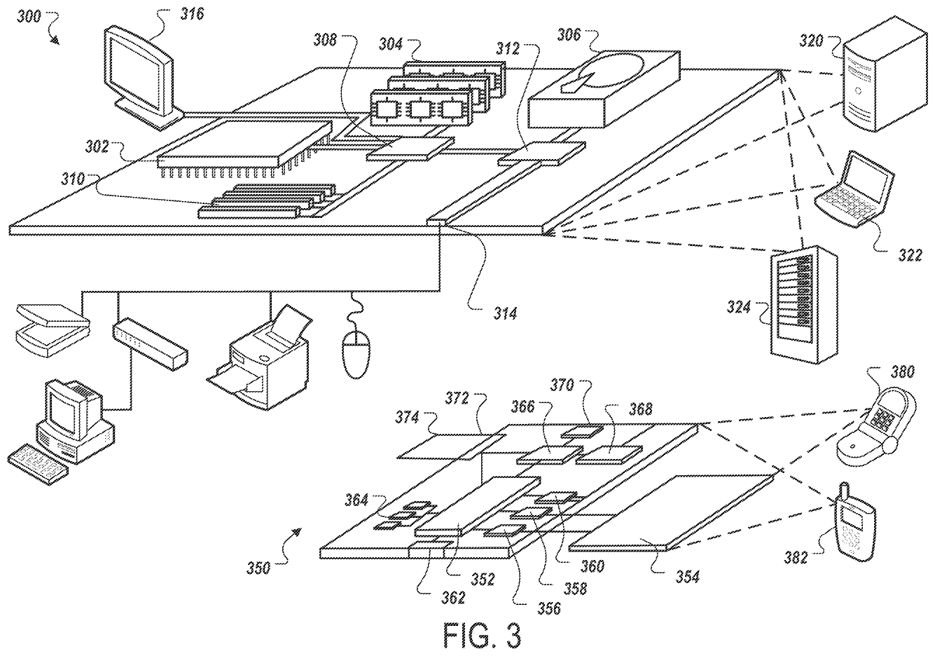

FIG. 3 is a diagram illustrating an example of a computing system used for oversampling training data. The computing system includes computing device 300 and a mobile computing device 350 that can be used to implement the techniques described herein. For example, one or more components of the system 100 could be an example of the computing device 300 or the mobile computing device 350, such as a computer system implementing the computer 102, devices that access information from the computer 102, or a server that accesses or stores information regarding the operations performed by the computer 102.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 302 is a single threaded processor. In some implementations, the processor 302 is a multi-threaded processor. In some implementations, the processor 302 is a quantum computer.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine readable mediums (for example, the memory 304, the storage device 306, or memory on the processor 302). The high-speed interface 308 manages bandwidth-intensive operations for the computing device 300, while the low-speed interface 312 manages lower bandwidth-intensive operations. Such allocation of functions is an example only. In some implementations, the high speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may include one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry in some cases. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 368 using a radio frequency. In addition, short-range communication may occur, such as using a Bluetooth, Wi-Fi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, among others) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method for training a machine-learning model using bias-reduced training data, the method comprising:
obtaining a first data set that includes data of multiple attribute levels including a minority level and a majority level;
extracting one or more samples from the first data set representing the minority level;
generating one or more values representing a distance between a sample of the minority level and the one or more samples of the minority level;
generating a sample rate for the minority level using the one or more values representing the distance;
generating a second data set by (i) sampling a second set of samples from a distribution using the sample rate and (ii) combining the second set of samples with the first data set;
providing a portion of the second data set to a machine learning model;
obtaining output of the machine learning model representing a prediction using the portion of the second data set;
comparing the output with a ground truth value included in a portion of the second data set not provided to the machine learning model; and
adjusting the machine learning model using one or more values indicating the comparison between the output and the ground truth value.

2. The method of claim 1, wherein the second data set includes more samples representing the minority level than the first data set.

3. The method of claim 1, wherein generating the one or more values representing the distance between the sample of the minority level and the one or more samples of the minority level comprises:
generating one or more values representing an average of each feature describing each sample of the first data set; and
generate one or more values representing a correlation of each feature describing each sample of the first data set.

4. The method of claim 3, wherein the one or more values representing the correlation include a covariance matrix.

5. The method of claim 3, comprising:
generating a transposition of the one or more values indicating the distance.

6. The method of claim 1, wherein generating the sample rate for the minority level using the one or more values representing the distance comprises:
combining a portion of the one or more values representing the distance;
modifying the combination of the portion of the one or more values using a reciprocal of a combination of the one or more values representing the distance; and
generating a matrix of values including the sample rate for the minority level using the modified combination of the portion of the one or more values.

7. The method of claim 1, comprising:
generating a second sample rate for a second minority level of the first data set or the majority level using the one or more values representing the distance, wherein the second sample rate is less than the sample rate for the minority level.

8. The method of claim 1, wherein the minority level represents one or more attributes with a likelihood of bias higher than one or more attributes represented by the majority level in the first data set, and wherein a bias of the one or more attributes of the minority level in the second data set is less than the one or more attributes of the minority level in the first data set.

9. The method of claim 8, wherein a higher bias indicates a greater likelihood of inaccurate results from the machine learning model.

10. A non-transitory computer-readable medium storing one or more instructions executable by a computer system to perform operations comprising:
obtaining a first data set that includes data of multiple attribute levels including a minority level and a majority level;
extracting one or more samples from the first data set representing the minority level;
generating one or more values representing a distance between a sample of the minority level and the one or more samples of the minority level;
generating a sample rate for the minority level using the one or more values representing the distance;
generating a second data set by (i) sampling a second set of samples from a distribution using the sample rate and (ii) combining the second set of samples with the first data set;
providing a portion of the second data set to a machine learning model;
obtaining output of the machine learning model representing a prediction using the portion of the second data set;
comparing the output with a ground truth value included in a portion of the second data set not provided to the machine learning model; and
adjusting the machine learning model using one or more values indicating the comparison between the output and the ground truth value.

11. The medium of claim 10, wherein the second data set includes more samples representing the minority level than the first data set.

12. The medium of claim 10, wherein generating the one or more values representing the distance between the sample of the minority level and the one or more samples of the minority level comprises:
generating one or more values representing an average of each feature describing each sample of the first data set; and
generate one or more values representing a correlation of each feature describing each sample of the first data set.

13. The medium of claim 12, wherein the one or more values representing the correlation include a covariance matrix.

14. The medium of claim 12, wherein the operations comprise:
generating a transposition of the one or more values indicating the distance.

15. The medium of claim 10, wherein generating the sample rate for the minority level using the one or more values representing the distance comprises:
combining a portion of the one or more values representing the distance;
modifying the combination of the portion of the one or more values using a reciprocal of a combination of the one or more values representing the distance; and
generating a matrix of values including the sample rate for the minority level using the modified combination of the portion of the one or more values.

16. The medium of claim 10, wherein the operations comprise:
generating a second sample rate for a second minority level of the first data set or the majority level using the one or more values representing the distance, wherein the second sample rate is less than the sample rate for the minority level.

17. The medium of claim 10, wherein the minority level represents one or more attributes with a likelihood of bias higher than one or more attributes represented by the majority level in the first data set, and wherein a bias of the one or more attributes of the minority level in the second data set is less than the one or more attributes of the minority level in the first data set.

18. The medium of claim 17, wherein a higher bias indicates a greater likelihood of inaccurate results from the machine learning model.

19. A system, comprising:
one or more processors; and
machine-readable media interoperably coupled with the one or more processors and storing one or more instructions that, when executed by the one or more processors, perform operations comprising:
obtaining a first data set that includes data of multiple attribute levels including a minority level and a majority level;
extracting one or more samples from the first data set representing the minority level;
generating one or more values representing a distance between a sample of the minority level and the one or more samples of the minority level;
generating a sample rate for the minority level using the one or more values representing the distance;
generating a second data set by (i) sampling a second set of samples from a distribution using the sample rate and (ii) combining the second set of samples with the first data set;
providing a portion of the second data set to a machine learning model;
obtaining output of the machine learning model representing a prediction using the portion of the second data set;
comparing the output with a ground truth value included in a portion of the second data set not provided to the machine learning model; and
adjusting the machine learning model using one or more values indicating the comparison between the output and the ground truth value.

20. The system of claim 19, wherein the second data set includes more samples representing the minority level than the first data set.
